(19) United States
(12) Patent Application Publication
(10) Pub. No.: US 2022/0186447 A1
(43) Pub. Date: Jun. 16, 2022

(54) Milling Machine with Adjustable Rotor Enclosure

(71) Applicant: Caterpillar Paving Products Inc., Brooklyn Park, MN (US)

(72) Inventors: Jason W. Muir, Andover, MN (US); Derek P. Nieuwsma, Loretto, MN (US); Nathaniel S. Doy, Maple Grove, MN (US); Matthew-David S. Frantz, Eden Prairie, MN (US)

(73) Assignee: Caterpillar Paving Products Inc., Brooklyn Park, MN (US)

(21) Appl. No.: 17/122,398

(22) Filed: Dec. 15, 2020

(51) Int. Cl. E01C 23/088; E01C 23/12; F15B 21/08; F15B 13/06; F15B 1/02

(52) U.S. Cl. CPC E01C 23/088; E01C 23/127; F15B 21/08; F15B 2211/40; F15B 1/02; F15B 2201/00; F15B 13/06

(57) ABSTRACT

A milling machine includes a cutting rotor accommodated in a rotor enclosure having side plates that are vertically adjustable with respect to a machine frame. To adjust the vertical elevation of the side plates, a plurality of sensors is mounted on the machine frame and associated with an electronic controller that measures and processes the vertical distance between the side plates and work surface. The electronic controller operates a hydraulic system to adjust the vertical distance between the side plates and the work surface. To accommodate changes in work surface topography, the hydraulic system includes a float circuit with an accumulator.

### TECHNICAL FIELD

This patent disclosure relates generally to a machine for milling a work surface such as a rotary mixer equipped with a cutting rotor accommodated in a rotor enclosure and, more particularly, to a system for adjusting components of the rotor enclosure with respect to a work surface.

### BACKGROUND

There exist various mobile machines for removing or milling matter such as pavement, asphalt, or concrete from a work surface such as a roadway or similar surfaces. For example, a rotary mixer is a type of mobile machine that includes a cutting rotor rotatably supported by a machine frame that can traverse a work surface by, for example, a plurality of wheels. As the rotary mixer travels over the work surface, the cutting rotor can be lowered into and penetrate the work surface and thereby fragment and break apart the top layer of the work surface. In the example of a rotary mixer, the fragments and debris is left on the work surface and can be reused as aggregate in a subsequent paving operation. In another example, a cold planer is a similar type of mobile machine with a cutting rotor operatively associated with a conveyor to receive and remove the debris from the work surface, for example, by directing the material to a dump truck leading or following the cold planer.

To contain the fragmented debris generated by the milling process and prevent it from dispersing around the rotary mixer or similar milling machine, the cutting rotor is typically accommodated in a rotor enclosure. The rotor enclosure is a box-like structure supported by the machine frame and which may include first and second side plates that extend in close proximity to the work surface. Because the work surface may be uneven, the side plates may unintentionally contact the work surface resulting in drag on the machine. Drag may result in sub-optimal performance of the milling machine and may possibly damage the machine.

To avoid unintentional contact between the rotor enclosure and the work surface, milling machines have been configured so that the vertical height of the side plate can adjusted. For example, U.S. Publication 2013/082508 (“the '508 publication”) describes a milling machine having a rotor enclosure with vertically adjustable side plates that can follow the contour of the work surface. In particular, each side plate is mounted to the rest of the rotor enclosure by a swivel bearing that enables the side plate to vertically pivot with respect to the work surface, thereby vertically adjusting the height of the side plate. The present disclosure is directed to an improved configuration of a milling machine with a rotor enclosure having vertically adjustable side plates.

### SUMMARY

The disclosure describes, in one aspect, a milling machine for milling a work surface like a roadway covered in asphalt or pavement. A milling machine includes a machine frame supported on a plurality of propulsion components for travel over the work surface. The machine frame defines a first lateral side and a second lateral side of the milling machine. To mill the work surface, a cutting rotor is rotatably supported by the machine frame. The cutting rotor is a cylindrical drum defining a rotor axis perpendicular to the first and second lateral sides of the machine frame. To accommodate the cutting rotor, a rotor enclosure is supported on the machine frame which can include a first side plate aligned with the first lateral side and a second side plate aligned with the second lateral side. The first and second side plates can be vertically movable with respect to the machine frame. To sense the location of the work surface with respect to the machine frame, the milling machine includes a plurality of sensors mounted to the machine frame at various locations. To adjust the vertical elevation of the first and second side plates, the milling machine includes a hydraulic system with first hydraulic actuator operatively associated with the first side plate and a second hydraulic actuator operatively associated with the second side plate. The milling machine also includes an electronic control unit in electronic communication with the plurality of sensors and operatively associated with the hydraulic system. The electronic controller is programmed with a side plate elevation control system adapted to operate the hydraulic system to raise at least one of the first side plate and the second plate if the vertical distance between the machine frame and the work surface decreases and to lower at least one of the first side plate and the second side plate if the vertical distance between the vertical distance and the machine frame increases.

In another aspect, the disclosure describes a method of operating a milling machine for milling a work surface like a roadway covered in asphalt or pavement. Using a plurality of sensors, the vertical distance between a machine frame of the milling machine and the work surface is sensed or measured. In response to the vertical distance as measures, the method can operate a hydraulic system to cause a side plate of a rotor enclosure accommodating the cutting rotor to rise with respect to the machine frame if the vertical distance between the machine frame and the work surface decreases. The method can also operate the hydraulic system to cause the side plate of the rotor enclosure accommodating the cutting rotor to lower with respect to the machine frame if the vertical distance between the machine frame and the work surface increases.

In yet another aspect of the disclosure, there is described a control system for a milling machine having a cutting rotor accommodated in a rotor enclosure for milling a work surface. The control system includes a plurality of sensors mounted to a machine frame to sense and generate sensor data indicative of a location of the work surface with respect to the machine frame. The control system is operatively associated with a hydraulic system that include at least a first hydraulic actuator operatively associated with a first side plate of the rotor enclosure and a second hydraulic actuator operatively associated with a second side plate of the rotor enclosure. The first and second hydraulic actuators are configured to vertically raise and lower the first side plate and the second side plate with respect to the machine frame. The control system is also associated with an electronic controller programmed with a plate elevation control system adapted to receive the sensor data from the plurality of sensors, process the sensor data to determine a vertical distance between the work surface and at least one of the first side plate and the second side plate, and to operate the hydraulic system to raise at least one of the first side plate and second side plate if the vertical distance decrease and to lower at least one of the first side plate and the second side plate if the vertical distance increases.

### BRIEF DESCRIPTION OF THE DRAWINGS

FIG. 1 is a perspective view of a milling machine for milling a work surface equipped with a cutting rotor accommodated in a rotor enclosure and a plurality of sensors to sense a vertical position of the machine frame relative to the work surface.

FIG. 2 is a perspective view of a rotor enclosure of the milling machine including a side plate arranged to be vertically adjusted with respect to the work surface.

FIG. 3 is a schematic representation of a plate elevation control system implemented in part as a hydraulic system and an electronic controller for raising and/or lowering the side plates of the rotor enclosure to accommodate topographical changes in the work surface.

FIG. 4 is a schematic block diagram of a computer implement method conducted by the plate elevation control system using a plurality of sensors and a hydraulic system to vertically adjust the height of the side plates with respect to the work surface.

### DETAILED DESCRIPTION

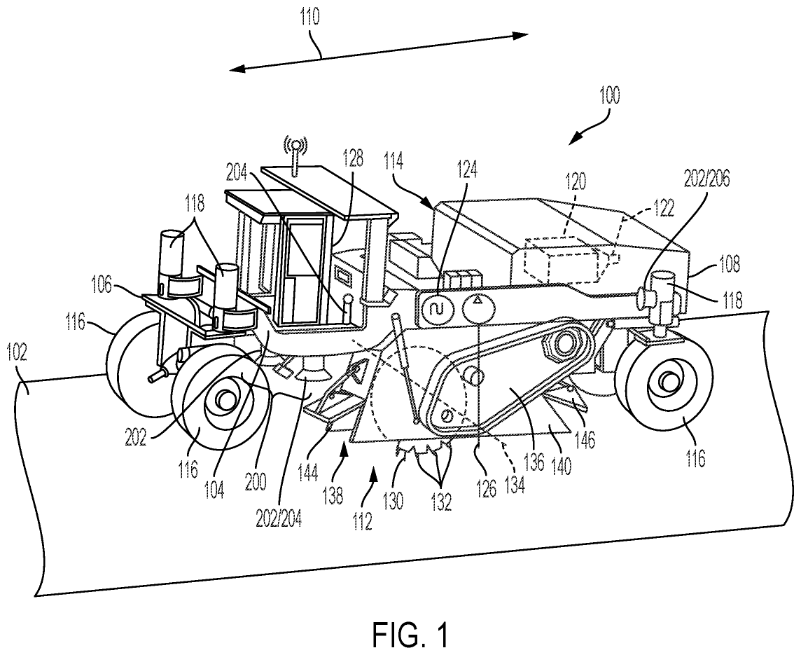

Now referring to the drawings, wherein whenever possible like reference numbers refer to like features, there is illustrated in FIG. 1 a machine in the particular embodiment of a rotary mixer 100 that, as familiar to those of skill in the art, are utilized in road repair and repaving operations. Rotary mixers 100 are configured to remove and reclaim or reuse a layer of a work surface 102 such as pavement, concrete, asphalt, or other material by penetrating into and fracturing the work surface in a milling operation. The fractured material may be redeposited on the work surface 102 where it can be used as a foundation or base aggregate in a subsequent paving operation. In addition to rotary mixers, the present disclosure is applicable to other milling machines such as road planers that can mill and remove a layer of the work surface, soil reclaimers for churning and relaying soil, and other machines used in work surface milling operations and similar operations in construction and agriculture.

The rotary mixer 100 can include a machine frame 104 that may be oriented with a forward end 106 and a rearward end 108 that are aligned along a travel axis 110 of the machine; however, because the rotary mixer 100 may operate in both forward and reverse directions, the designations are used herein primarily for reference purposes. The machine frame 104 may also include a first lateral side 112 and an opposite second lateral side 114, which, depending upon the orientation of the observer, may correspond to the left hand side or the right hand side of the rotary mixer 100. The first and second lateral sides 112, 114 are again used herein for reference and orientation purposes and are arbitrary.

To support the rotary mixer 100 on the work surface 102, the machine frame 104 can be supported on a plurality of propulsion components 116. In the illustrated embodiment, the propulsion components 116 can be rotatable wheels that can include rubber pneumatic tires. The wheels may be designated as powered drive wheels to propel the rotary mixer 100, steerable wheels to adjust direction of the rotary mixer, or combinations thereof. Another suitable embodiment of propulsion components 116 include continuous tracks such as a closed belt disposed about rollers and/or sprockets where translation of the belt carries the rotary mixer 100 over the work surface 102. To vertically raise and lower the rotary mixer 100 with respect to the work surface 102, the machine frame 104 can be coupled to the propulsion components 116 by a plurality of lifting columns 118. The telescopic lifting column 118 can independently extend and retract to adjust the height, grade, and slope of the machine frame 104 relative to the work surface 102. In an embodiment, the lifting columns 118 can be located at the forward end 106 and at the rearward end 108 toward either lateral side 112, 114 so that the pitch, slope, and/or grade of the rotary mixer 100 can be selectively altered.

To power the propulsion components 116, lifting columns 118, and other systems of the rotary mixer 100, a power source such as an internal combustion engine 120 can be disposed on the machine frame 104. The internal combustion engine 120 can burn a hydrocarbon-based fuel like diesel or gasoline and convert the latent chemical energy therein to a mechanical motive force in the form of rotary motion that can be harnessed for other useful work. The rotary output of the engine 120 can be transmitted through a crankshaft 122 extending from the engine and operatively coupled to the propulsion components 116 and other systems. For example, the engine 120 can be operatively coupled to and drive other power systems on the rotary mixer such as an electrical generator 124 to generate electricity for an electrical system and a hydraulic pump 126 for pressurizing and directing hydraulic fluid for a hydraulic system.

To accommodate an operator, the rotary mixer 100 can include an onboard operator cab or operator station 128 on the machine frame 104 at a location that provides visibility over and about the work surface 102 for conducting the milling operation. The operator station 128 can include various controls, readouts, and other input/output interfaces for monitoring and controlling operation of the rotary mixer 100. For example, the operator station 128 can include steering joysticks or steering handles for adjusting the travel direction of the rotary mixer 100, speed controls for adjusting the travel speed of the rotary mixer 100, and elevation controls for adjusting the vertical distance between the machine frame 104 and the work surface 102 via the lifting columns 118. In other embodiments, the rotary mixer 100 may be configured for remote operation and some or all of the foregoing operator controls may be located remotely from the onboard operator station 128.

To engage and fragment the work surface 102, the rotary mixer 100 can include a power driven cutting rotor 130 rotatably supported by the machine frame 104. The cutting rotor 130 can be a drum-shaped, cylindrical structure having a plurality of picks or teeth-like cutting tools 132 disposed about its cylindrical surface. As the cutting rotor 130 rotates, the cutting tools 132 impact and penetrate into the work surface 102 fracturing the material thereof. The cutting tools 132 are adapted to penetrate into the work surface 102 and remove a portion of the material as the rotary mixer 100 advances along the travel axis 110 through a process referred to as milling or planning. In some embodiments, the cutting tools 132 may be removable from the cutting rotor 130 for replacement as they become worn or damaged. The cutting rotor 130 can rotate about a rotor axis 134 that extends between the first and second lateral sides 112, 114 of the machine frame 104 and that is generally perpendicular to the travel axis 110.

To contain the fragmented material and debris, the cutting rotor 130 can be rotatably accommodated in a housing or rotor enclosure 136 that extends from the machine frame 104 toward the work surface 102. The rotor enclosure 136 defines an enclosed space 138 in which the cutting rotor 130 is located. The rotor enclosure 136 can be located approximately mid-length on the machine frame 104 between the forward end 106 and the rearward end 108 so that the machine weight can be disposed on the cutting rotor 130 to maintain a uniform cut depth. In the embodiment of the rotary mixer 100 used in a work surface reclamation process, the enclosed space 138 defined by the rotor enclosure 136 can function as a mixing chamber that can be operatively associated with other systems to receive water or other materials for mixing with the fragmented debris. When the cutting rotor 130 rotates in the rotor enclosure 136, the rotation mixes the fragments and materials that can be redeposited on the work surface 102.

To define the enclosed space 138, the rotor enclosure 136 is arranged as a box-like structure and can be formed from a plurality of metal plates. For example, the rotor enclosure 136 can include a first side plate 140 that is aligned with the first lateral side 112 of the rotary mixer 100 and a second side plate 142 that is aligned with the second lateral side 114 of the rotary mixer 100. The first and second side plates 140, 142 can be planar structures that are arranged vertically with respect to the machine frame 104 at the respective first and second lateral sides 112, 114 and can extend proximately toward the work surface 102. The rotor axis 134 is therefore perpendicular to the first and second side plates 140, 142. To complete the box-like structure of the rotor enclosure 136, the rotor enclosure 136 can include a forward door 144 and a rearward door 146 that are arranged perpendicular to and extend between the first and second side plates 140, 142. In an embodiment, the forward door 144 and rearward door 146 are connected via hinges to the machine frame 104 so the volume of the enclosed space 138 can be adjusted.

The first and second side plates 140, 142 and the forward and rearward doors 144, 146 surround and substantially enclose the cutting rotor 130 within the enclosed space 138. It will be appreciated that the bottom of the rotor enclosure 136 remains open so that the lower cylindrical segment of the cutting rotor 130 can protrude from the enclosed space 138 and contact the work surface 102.

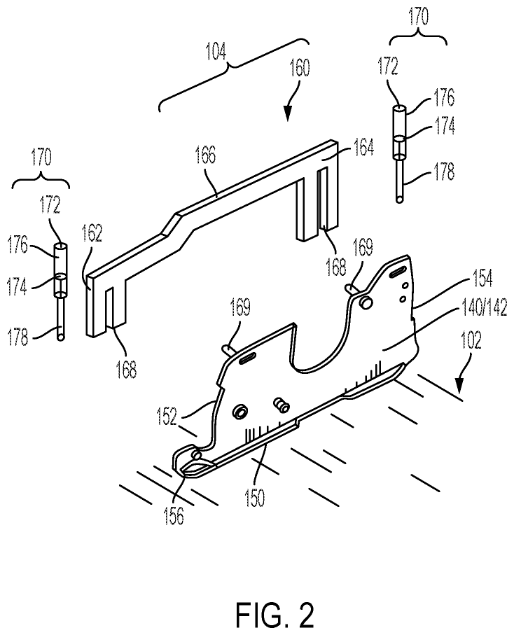

As indicated above, to ensure that most of the fragmented material is retained in the rotor enclosure 136, the first and second side plates 140, 142 extend in close proximity to the work surface 102. Referring to FIG. 2, to abut against the work surface 102 in intermittent contact during a milling operation, the lower edges of the first and second side plates 140, 142 can include ski-shaped skid plates 150 that provide a planar surface adjacent and opposed to the work surface 102 and orthogonal to the main panel of the first and second side plates 140, 142. The ski-shaped skid plates 150 can contact and traverse over the work surface 102 allowing the first and second side plates 140, 142 to slide over the work surface. The skid plates 150 can extend partially or complete along the lower edge between a forward edge 152 and rearward edge 154 of the planar side plates 140, 142. To physically encounter the work surface 102, the forward tip 156 of the skid plate 150 can be curved or angled upwards.

Despite inclusion of the skid plates 150, it can be appreciated that the first and second side plates 140, 142 can penetrate too far into the work surface 102 resulting in excessive drag on the rotary mixer 100. This can result in excessive fuel consumption and may damage the side plates 140 142, and may negatively affect the mixing operation. The side plates 140, 142 can also get bound up in material between the sides plates and the enclosed space 138 causing the cutting rotor 130 to become exposed under some circumstances. Accordingly, to maintain close proximity between the lower edges of the first and second side plates 140, 142 and the work surface 102 while avoiding excessive penetration, the relative position of the first and second side plates 140, 142 can be vertically adjusted with respect to the machine frame 104 and thus the work surface 102.

Referring to FIG. 2, to enable the vertical adjustment of the first and second side plates 140, 142, the first and second side plates can operatively interact with a respective plate frame 160 that is fixedly mounted to the machine frame 104. The plate frame 160 can be a structural component made of metal that has an outline that generally corresponds in shape to the peripheral edges of the first and second side plates 140, 142. For example, the plate frame 160 can include a first vertical leg 162 and a second vertical leg 164 that are joined and spaced apart by a horizontal bar 166. When the first and second side plates 140, 142 are placed adjacent to the plate frame 160, the first and second vertical legs 162, 164 align with the forward and rearward edges 152, 154 and the horizontal bar 166 extends along the longitudinal length of the side plates 140, 142. However, the illustrated embodiment of the plate frame 160 is exemplary only and other arrangements by which the side plates 140, 142 interact with the machine frame 104 can be constructed.

To guide the vertical adjustment of the side plates 140, 142 with respect to the plate frame 160, the first and second vertical legs 162, 164 can each have guide slots 168 disposed therein. The guide slots 168 can extend from the lower tips of the vertical legs 162, 164 toward the horizontal bar 166. To interact with the guide slots 168, the first and second side plates 140, 144 can each include one or more guide pins 169 protruding from a lateral surface of the side plates parallel with the rotor axis 134. The guide pins 169 can be received in and travel upwards and downwards with respect to the guide slots 168, thereby allowing guided vertical movement of the first and second side plates 140, 142 with respect to the plate frame 160.

To physically raise and lower the first and second side plates with respect to the plate frame 160, the first and second side plates 140, 142 can be operatively associated with a hydraulic system 170 including one or more hydraulic actuators 172 disposed in the rotor enclosure 136 of the rotary mixer. One or more hydraulic actuators 172 can be associated with each of the first and second side plates 140, 142. The hydraulic actuators 172 can, in an embodiment, be double acting hydraulic cylinders. The hydraulic cylinders include a piston 174 that is slideably received in a hollow barrel 176. The piston 174 and the hollow barrel 176 can be circular or cylindrical in shape to facilitate relative sliding motion between the components. The piston 174 is connected to a rod 178 that protrudes through one end of the hollow barrel 176. The protruding end of the rod 178 can be connected to the side plates 140, 142 and the hollow barrel 176 can be connected to the plate frame 160 or another part of the machine frame 104. When pressurized hydraulic fluid is directed to and from the hydraulic actuators 172, the fluid pressure causes the piston 174 to move within the hollow barrel 176 thereby extending and retracting the rod 178. Because the hydraulic actuators are connected between the side plates 140, 142 and the plate frame 160, extension and retraction of the rod 178 changes the relative position of the components by raising and lowering the side plates with respect to the machine frame 104.

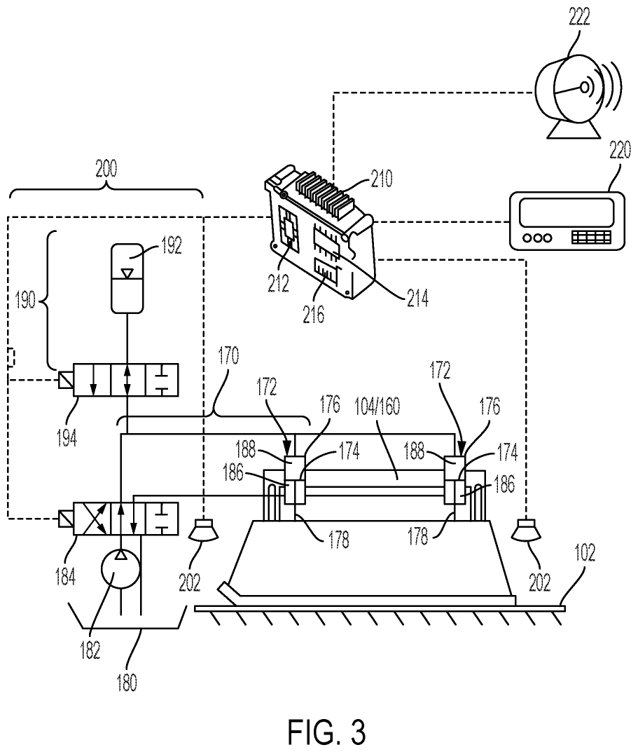

Referring to FIG. 3, to supply hydraulic fluid that actuates the hydraulic actuators 172, the hydraulic system 170 can include a tank or hydraulic reservoir 180. The hydraulic reservoir 180 can be an enclosed volume that holds low-pressure hydraulic fluid. The hydraulic fluid can be any suitable type of incompressible fluid such as lubrication oil and the like and can have a sufficient viscosity to readily flow within the hydraulic system. To pressurize the hydraulic fluid and direct it from the hydraulic reservoir 180 through the hydraulic system 170, the system can include one or more hydraulic pumps 182. The hydraulic pump 182 can be any suitable type of pump for pressurizing and positively displacing hydraulic fluid in a circuit including, for example, piston pumps, rotary gear pumps, vane pumps, gerotor pumps, swash plates and the like. To communicate the hydraulic fluid between the hydraulic pump 182 and the hydraulic actuators 172, the hydraulic system 170 can include appropriate hydraulic conduits such as flexible hoses or rigid tubing.

To selectively direct and control the flow of pressurized hydraulic fluid to and from the hydraulic actuators 172, the hydraulic system can include one or more flow control or direction control valves. For example, a first flow control valve or actuator flow control valve 184 can be operatively disposed between the hydraulic actuator 172 and the hydraulic pump 182. The actuator flow control valve 184 can be a multi-directional valve to direct hydraulic fluid to either the head end or the cap end of the hydraulic actuator. More particularly, in an embodiment, the actuator flow control valve 184 can be a solenoid operated spool valve including an electromagnetic solenoid for changing the position of an internal spool that may be biased against one or more springs. When the solenoid is activated, the solenoid moves the internal spool to seal and unseal various ports to establish fluid communication with the hydraulic actuators 172.

In the illustrated embodiment where the hydraulic actuator 172 is a double acting hydraulic cylinder, the piston 174 can separate the hollow barrel 176 into a first head end 186 through which the rod 178 protrudes and a second cap end 188 opposite the first head end. To lower or raise the side plates 140, 142 with respect to the machine frame 104, the hydraulic system can selectively direct hydraulic fluid to and from either the head end 186 or cap end 188. For example, the actuator flow control valve 184 can be placed in a first actuator configuration in which pressurized hydraulic fluid is directed to the cap end of the hydraulic actuator. Also when in the first actuator configuration, the actuator flow control valve 184 can established fluid communication between the head end 186 and the hydraulic reservoir 180 so that any hydraulic fluid therein is returned to the reservoir. The first actuator configuration causes the piston 174 to move within the hollow barrel 176 toward the head end 186, thereby extending the rod 178 and vertically lowering the side plates 140, 142 with respect to the machine frame 104. To vertically raise the side plates 140, 142, the actuator flow control valve 184 can be configured in a second actuator configuration in which pressurized hydraulic fluid is directed to the head end 186 and the cap end 188 is placed in fluid communication with the hydraulic reservoir 180. In the second actuator configuration, the piston 174 is moved toward the cap end 188 retracting the rod 178 into the hollow barrel 176 and vertically raising the side plates 140, 142 with respect to the machine frame 104.

If the actuator flow control valve is maintained in either the first or second actuator configurations, the first and second side plates 140, 142 may be moved to and held or locked in a fully raised or fully lowered position relative to the machine frame 104. In an embodiment, the actuator flow control valve 184 may include a third actuator configuration in which the hydraulic actuator 172 is isolated from the hydraulic system 170 and the first and second side plates 140, 142 can be held or maintained in an intermediate position between the fully raised and fully lowered positions.

In an embodiment, to accommodate sudden and temporary changes in the topology of the work surface 102, for example, if the first and second side plates 140, 142 encounter a ditch or a mound, the hydraulic system 170 can include a distinct float circuit 190. The float circuit 190 is configured to enable the first and second side plates 140, 142 to temporarily rise with respect to the machine frame 104 if the vertical distance decreases and to temporarily lower the first and second side plates 140, 142 with respect to the machine frame 104 if the vertical distance between the machine frame and work surface increases. After the first and second side plates 140, 142 pass the object on or void in the work surface 142, the float circuit allows the side plates to return to their previous vertical position with respect to the work surface. To enable the first and second side plates to temporarily raise and lower with respect to the machine frame 104, the float circuit 190 can include an accumulator 192, which may be a pressure tank of a particular volume into or out of which pressurized hydraulic fluid can be directed from hydraulic system 170. The accumulator 192 thus can hold pressurized hydraulic fluid temporarily for reuse in the hydraulic system 170. In contrast to the rest of the hydraulic system 170 that vertically moves and actively holds the first and second side plates 140, 142 under positive hydraulic pressure from the hydraulic pump 182, the float circuit 190 utilizes a more passive approach in which hydraulic fluid is temporally displaced to and from the accumulator by external forces applied to the hydraulic actuators through the first and second side plates 140, 142.

To selectively direct hydraulic fluid to and from the accumulator 192, the float circuit 190 can include a second flow control valve or accumulator flow control valve 194 disposed between and in fluid communication with the hydraulic actuators 172 and the accumulator 192. The accumulator flow control valve 194 can also be a solenoid-actuated valve having an electromagnetic solenoid that can moveably shift an internal spool to open and close ports in the valve body. The accumulator flow control valve 194 can be placed in a first float configuration in which hydraulic fluid can be directed from the cap end 188 of the hydraulic actuator 172 to the accumulator 192. In the event the first and second slide plates 140, 142 encounter a decrease in vertical distance between the work surface 102 and machine frame 104, the piston 174 moves in the hollow barrel 176 to displace hydraulic fluid from the cap end 188 to the accumulator 192.

The accumulator flow control valve 194 can also be configured in a second float configuration in which pressurized hydraulic fluid temporarily accommodated in the accumulator 192 can be directed to the hydraulic actuator to supplement or increase the hydraulic fluid from the hydraulic pump 182. In an embodiment, instead of the first flow configuration and second float configuration, the accumulator flow control valve 194 can be a bidirectional valve the establishing fluid flow in either direction between the hydraulic actuator 172 and the accumulator 192. Accordingly, if the first and second side plates 140, 142 encounter a sudden increase in vertical distance between the work surface 102 and machine frame 104, the side plates 140, 142 can be responsively lowered to maintain the close proximity between the skid plate 150 and the work surface 102.

In an embodiment, the accumulator flow control valve 194 can include a third float configuration in which the accumulator 192 is cutoff or isolated from the hydraulic actuators 172. Isolating the accumulator 192 may be desirable if the vertical elevation of the side plates 140, 142 should be maintained regardless of the topography of the work surface 102 or, for example, if the rotary mixer 100 is not actually engaged in a milling operation but is traveling about the work site or undergoing maintenance.

To control the relative vertical position between the machine frame 104 and the first and second side plates 140, 142 of the rotor enclosure 136, the rotary mixer 100 can include a plate elevation control system 200. Referring to FIGS. 1 and 3, the plate elevation control system 200 can include a plurality of sensors 202 fixedly mounted to the machine frame 104 to sense or measure the relative vertical distance between the machine frame 104 and the work surface 102. By fixedly mounting the plurality of sensors 202 to the machine frame 104, the sensors can provide a fixed and known reference point based upon their pre-known location on the machine frame. In an embodiment, the plurality of sensors 202 can be sonic or acoustic sensors that emit an acoustic wave toward an object to be measured such as the work surface 102. The acoustic wave can be reflected back toward the sensors 202 and the travel time between emitting the acoustic wave and receiving the reflection can be converted to relative distance. In another example, the plurality of sensors 202 can be laser sensors, infrared sensors, or ultraviolet sensors that operate on similar emission and reflection of electromagnetic radiation. The plate elevation control system 200 can also use other suitable types of sensors and/or smart cameras configured to measure relative distances.

To measure or sense the topography of the work surface 102 as the rotary mixer 100 moves along the travel axis 110, the plurality of sensors 202 can include forward sensors 204 that are disposed at a suitable location on the forward end 106 of the machine frame 104. For example, the forward sensors 204 can be located on the underside of the operator station 128 at the forward end 106 and can be oriented to project acoustic waves forwardly of the rotary enclosure 136 with respect to the travel axis 110. In an embodiment, the forward sensors 204 can be a pair of sensors with one sensor being aligned with one of the respective first and second lateral sides 112, 114 of the rotary mixer 100. Accordingly, the forward sensors 204 can sense or measure the work surface 102 being approached by the rotary mixer 100. The plate elevation control system 200 can also include a pair of rearward sensors 206 disposed on the rearward end 108 of the rotary mixer 100, for example on the lifting columns 118, to sense or measure the topography of the work surface 102 passing under the rotary mixer 100 behind the rotor enclosure 136. In other embodiments, the plurality of sensors may be located at other suitable location about the machine frame 104.

From the predetermined locations of the plurality of sensors 202 disposed about the rotary mixer 100 and the pre-known dimensions of the machine frame 104, the plate elevation control system 200 can determine the relative vertical distance between the rotor enclosure 136 and the work surface 102. To enable determination of the relative distances, referring to FIG. 3, the plate elevation control system 200 can include or be operatively associated with an electronic controller 210, sometimes referred to as an electronic control module (ECM) or an electronic control unit (ECU). To perform or conduct the associated functions and operations of the plate elevation control system 200, the electronic controller 210 can include one or more microprocessors 212 such as a central processing unit (CPU), an application specific integrated circuit (ASIC), a field programmable gate array (FPGA), or other appropriate processing circuitry. The electronic controller 210 can also include non-transient data and programmable memory 214, which may be in the form of random access memory and/or more permanent forms of data storage for storing software associated with the plate elevation control system. The microprocessor 212 may be capable of processing or performing any suitable computer-based functions, such as executing instructions, data processing, mathematical operations, and the like. The electronic controller 210 may also include input/output ports 216 and associated circuitry to communicate with other electronic devices including, for example, the plurality of sensors 202. The electronic controller 210 may be associated with other software including any suitable instruction sets, programs, applications, routines, libraries, databases and the like, for carrying out its functions. The electronic controller 210 can be dedicated to implementing the plate elevation control system 200 or may also operatively control or regulate other systems and equipment associated with the rotary mixer 100. Although in FIG. 3, the electronic controller 210 is illustrated as a single, discrete unit, in other embodiments, the electronic controller 210 and its functions may be distributed among a plurality of distinct and separate components.

The electronic controller 210 can be in electronic communication with the plurality of sensors 202 to receive electronic signals and data related to the measured relative vertical distance between the work surface 102 and the machine frame 104. In addition, to responsively adjust the relative height of the first and second side plates 140, 142 with respect to the machine frame 104 and thus the work surface 102, the plate elevation control system 200 can regulate and control operation of the hydraulic system 170 including the float circuit 190. For example, the electronic controller 210 can electronically communicate with the actuator flow control valve 184 of the hydraulic system 170 and the accumulator flow control valve 194 of the float circuit 190. The electronic controller 210 can send electronic signals to actuate the actuator and accumulator flow control valves 184, 194 and reconfigure them between the different actuator and/or float configurations. Thus, the plate elevation system 200 controls the direction of hydraulic fluid to and from the hydraulic actuators 172 and thus can raise and lower the first and second side plates 140, 142 with respect the machine frame 104 and work surface 102.

### INDUSTRIAL APPLICABILITY

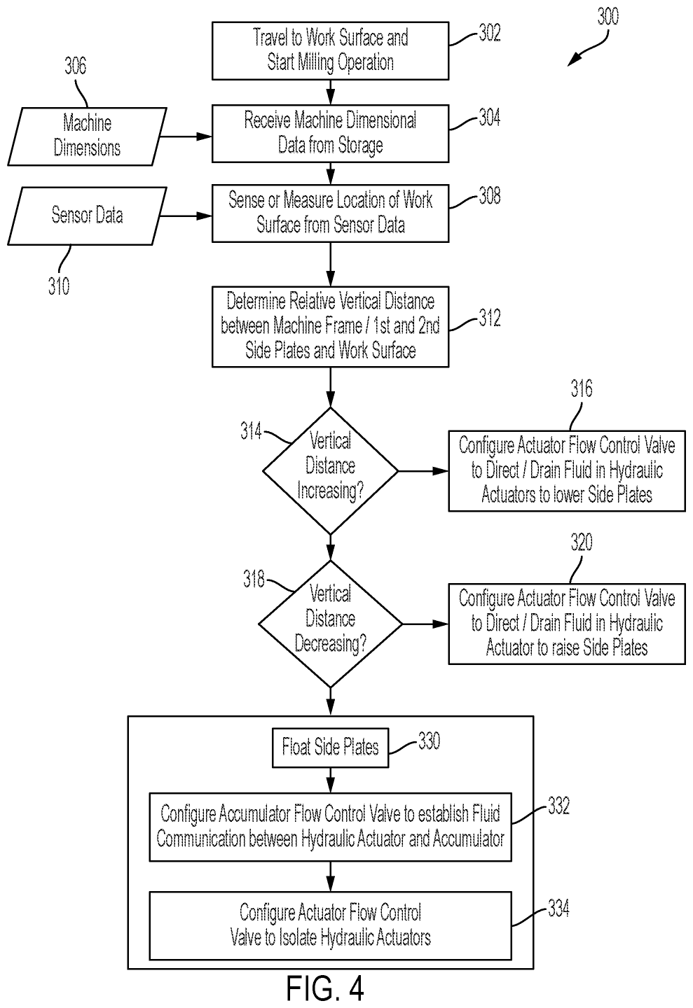

The disclosure is applicable to adjusting and controlling the elevation or vertical position of components of a rotor enclosure 136 with respect to the work surface 102 on a milling machine like a rotary mixer 100 or cold planer to avoid excessive drag or possible damage. Referring to FIG. 4, and in accordance with the prior figures, there is illustrated an exemplary process 300 that can be performed or executed by the plate elevation control system 200. The process 300 depicted in the flow diagram for accomplishing these tasks may include a series of steps or instructions implemented as non-transitory computer executable software code in the form of an application or program. The process 300 can be initiated by a starting step 302 in which the rotary mixer 100 travels to a location at the work surface 102 where the milling operation is to be conducted. Prior to the milling operation, the cutting rotor 130 and the first and second side plates 140, 142 may be vertically retracted with respect to the machine frame 104 to enable the rotary mixer 100 to travel about the work surface 102 at a relatively high rate of speed. Once the milling operation starts in the starting step 302, the first and second side plates 140, 142 can be vertically lowered so that the skid plates 150 on the lower edges thereof are proximate to the work surface 102 to contain material within the rotor enclosure 136.

To assess the relative vertical distance of the side plates 140, 142 with respect to the work surface 102 during the milling operation, the process 300 conducted by the plate elevation control system 200 can include a data receiving step 304 in which machine dimensional data 306 regarding the machine frame 104 can be read and received from, for example, memory 214 or similar data storage associated with the electronic controller 210. The machine dimensional data 306 is typically predetermined by the design dimensions of the rotary mixer 100 and can be pre-stored in memory 214 in the form of lookup tables, databases, and the like. The machine dimensional data 306 includes dimensional data regarding relative locations and distances between the various components of the rigid and fixed machine frame 104.

In a measurement or sensing step 308, the plate elevation control system 200 can use plurality of sensors 202 to obtain the location of the work surface 102 relative to a particular location or reference point on the rotary mixer 100, for example, the location each of the respective sensors 202. In the embodiment of an acoustic sensor or a laser, infrared, or ultraviolet sensor, this can be accomplished by the emission and reflection technology described above. In an embodiment, the plurality of sensors 202 can transmit sensor data 310 in the form of analog or digital electronic signals to the electronic controller 210 where the sensor data can be converted, via the processing capabilities associated with the electronic controller, to the location of the work surface 102. In other embodiments, the plurality of sensors 202 can include processing capabilities enabling the sensors themselves to measure the location of the work surface in terms of, for example, inches or centimeters.

In a determination step 312 in the process 300, the plate elevation control system 200 can use the machine dimensional data 306 and the sensor data 310 representing the location of the work surface 102 to determine the relative vertical distance between the work surface 102 and a reference point on the machine frame 104, for example, the skid plates 150 or the lower edges of the first and second side plates 140, 142. For example, the electronic controller 210 can accomplish the determination step 312 by conducting appropriate calculations written in machine executable form. If the reference point is the skid plate 150 or the lower edge of the first and second side plates 140, 142, the process 300 being conducted by the plate elevation control system 200 can obtain readings regarding the present location of the side plates with respect to the machine frame 104, for example, by sensing the extension or retraction of the hydraulic actuators 172 operatively associated with machine frame and side plates. As a result of the determination step 312, the plate elevation control system 200 knows or has determined the relative vertical distance between the work surface 102 and the first and second side plates 140, 142.

For the plate elevation control system 200 to utilize the relative vertical distance between the components, the process 300 can include one or more decision steps. For example, in a first decision step 314, the vertical distance as determined can be compared with a predetermined threshold or baseline to decide if the vertical distance between the work surface 102 and the first and second side plates 140, 142 is increasing. In another embodiment, the instantaneous magnitude of the vertical distance may be directly and repeatedly monitored to determine if it is growing/increasing or shrinking/decreasing. If yes, then to prevent fragmented material from unintentionally escaping the rotor enclosure 136 through the space between the work surface 102 and the first and second side plates 140, 142, the plate elevation control strategy 200 can commence a first configuration step 316 of the process 300 to responsively adjust operation of the hydraulic system 170 to lower the first and second side plates 140, 142 with respect to the machine frame 104 and thus the work surface 102.

For example, referring to FIG. 3, the plate elevation control system 200 can operatively configure the actuator flow control valve 184 in the first actuator configuration thereby directing pressurized hydraulic fluid to the cap end 188 of the hydraulic actuator 172. Also in the first actuator configuration, the actuator flow control valve 184 can establish fluid communication between the head end 186 and the hydraulic reservoir 180 so that hydraulic fluid is returned to the reservoir. This first actuator configuration of the actuator flow control valve 184 causes the rod 178 to extend from the hollow barrel 176 of the hydraulic actuator 172 thereby lowering the respective first or second side plate 140, 142 with respect to the work surface 102.

Alternately, the process 300 can include a second decision step 318 in which the relative vertical distance between the work surface 102 and the first and second side plates 140, 142 is compared to a threshold or baseline to determine if the vertical distance is decreasing. In another embodiment, the instantaneous magnitude of the vertical distance may be directly and repeatedly monitored to determine if it is growing/increasing or shrinking/decreasing. If yes, then to prevent the first and second side plates 140, 142 from impacting too far into the work surface 102, the plate elevation control strategy 200 can commence a second configuration step 320 to responsively adjust operation of the hydraulic system 170 to raise the first and second side plates 140, 142 with respect to the machine frame 104 and thus the work surface 102.

For example, the plate elevation control system 200 can operatively configure the actuator flow control valve 184 in the second actuator configuration thereby directing pressurized hydraulic fluid to the head end 186 of the hydraulic actuator 172. Also in the second actuator configuration, the actuator flow control valve 184 can establish fluid communication between the cap end 188 and the hydraulic reservoir 180 so that hydraulic fluid is returned to the reservoir. The second actuator configuration of the actuator flow control valve 184 causes the rod 178 to retract into the hollow barrel 176 of the hydraulic actuator 172 thereby raising the respective first or second side plate 140, 142 with respect to the work surface 102.

In an embodiment, the plate elevation control system 200 can carry out the process 300 continuously or repetitively by returning to the data receiving step 304 and sensing step 308. The process 300 thus is a loop that can continuously respond to changes in the topography of the work surface 102.

In a further embodiment of the disclosure, the first and second side plates 140, 142 can be operated independently of each other. For example, referring to FIGS. 1 and 3, the plate elevation control system 200 can process the sensor data from the plurality of sensors 202 associated with the first lateral side 112 of the machine frame 104 distinctly from the sensor data from the plurality of sensors 202 associated with the second lateral side 114 of the machine frame 104. The plate elevation control system 200, via the determination step 312, can therefore determine the relative vertical distance between the first side plate 140 and the work surface 102 independently of determining the relative vertical distance between the second side plate 142 and the work surface 102. Independent assessment of the vertical distances accounts for differences in topography of the work surface 102 that correspond to the first lateral side 112 compared to the second lateral side 114 of the machine frame 104. To independently adjust the relative vertical distances between the first and second side plates 140, 142 and the work surface 102, the hydraulic system 170 can include at least two actuator flow control valves 184 with one each operatively associated with the respective side plate aligned with either the first or second lateral sides 112, 114.

Once the plate elevation control system 200 has actively responded to adjust the vertical position between the work surface 102 and the first and second side plate 140, 142, to accommodate sudden and temporary changes in the topography of the work surface 102, the plate elevation control system 200 can commence a float step 330 to activate the float circuit 190. For example, the float step 330 can include a third configuration step 332 in which the plate elevation control system 200 configures the accumulator flow control valve 194 in the first or second float configurations to establish fluid communication between the hydraulic actuators 172 and the accumulator 192. Also, as mentioned, the accumulator flow control valve 194 can be a bidirectional valve establishing fluid flow in either direction between the hydraulic actuator 172 and the accumulator 192. In an embodiment, the float step 330 can optionally conduct a fourth configuration step 334 in which the actuator flow control valve 184 is configured into the third actuator configuration to isolate and cutoff the hydraulic actuator 172 from the hydraulic reservoir 180 and hydraulic pump 182. Isolating the hydraulic actuators 172 from the rest of the hydraulic system 170 during the float step 330 may prevent damages to the hydraulic system 170 in the event of sudden pressure changes due to movement of the side plates 140, 142 caused by changes in to topography of the work surface 102.

The float circuit 190 thereby allows the first and second side plates 140, 142 to float with respect to the work surface 102. For example, if the side plates 140, 142 encounter a sudden raise in the work surface 102, causing the side plates to move vertically upward with respect to the machine frame 104, hydraulic fluid in the cap end 188 of the hydraulic actuator 172 can be directed to the accumulator 192 allowing the rod 178 to retract into the hollow barrel 176 accommodating the vertical movement of the side plate 140, 142. Likewise, if the side plates 140, 142 encounter a void in the work surface 102, pressurized hydraulic fluid from the accumulator 192 can flow to the cap end 188 of the actuator 172 extending the rod 178184 and temporarily lowering the side plates with respect to the machine frame 104 and the work surface 102. The float circuit 190 thereby maintains the close proximity between the work surface 102 and the first and second side plates 140, 142 even during abrupt and temporary changes in topology while preventing damage to the other components of the hydraulic system 170. The float circuit 190 operates distinctly from the rest of the hydraulic system 170 in that it is responsive to external forces applied to the first and second side plates 140, 142 from the work surface 102.

In various embodiments, the plate elevation control system 200 can conduct additional steps or sub-operations to improve the milling operation of the rotary miller 100 or similar machine. For example, the plate elevation control system 200 may be operatively associated with a visual display or human machine interface 220 that can provide a visual representation or a numerical representation of the determined vertical distance between the work surface 102 and the first and second side plates 140, 142, which can be relied on to adjust the vertical position of the side plates during onboard or remote operation. The plate elevation control system 200 can also save data regarding the relative vertical position of the first and second side plates 140, 142 and the machine frame 104. This data can be collected on stored during different cuts or passes made by the cutting rotor 130 and used to optimize operation of the rotary mixer 100 during future operation. The data can be stored onboard in memory 214 associated with electronic controller 210 or transmitted off board via a transmitter 222 operatively associated with a telematics system.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A milling machine comprising:
a machine frame supported on a plurality of propulsion components for travel over a work surface, the machine frame defining a first lateral side and a second lateral side;
a cutting rotor rotatably supported by the machine frame for milling a work surface, the cutting rotor shaped as a cylindrical drum defining a rotor axis perpendicular to the first lateral side and second lateral side;
a rotor enclosure supported on the machine frame to accommodate the cutting rotor, the rotor enclosure including a first side plate aligned with the first lateral side and a second side plate aligned with the second lateral side, the first side plate and the second side plate vertically movable with respect to the machine frame;
a plurality of sensors mounted to the machine frame and arranged to sense a location of the work surface with respect the machine frame;
a hydraulic system including a first hydraulic actuator operatively associated with the first side plate and a second hydraulic actuator operatively associated with the second side plate, the hydraulic system configured to raise and lower the first side plate and the second side plate with respect to the machine frame; and
an electronic controller in electronic communication with the plurality of sensors and operatively associated with the hydraulic system, the electronic controller programmed with a plate elevation control system adapted to operate the hydraulic system to raise at least one of the first side plate and the second side plate if a vertical distance between the machine frame and the work surface decreases and to lower at least one of the first side plate and the second side plate if the vertical distance between the vertical distance and the machine frame increases.

2. The milling machine of claim 1, wherein the plate elevation control system is operatively associated with an actuator flow control valve disposed between the first and second hydraulic actuators and a hydraulic pump in fluid communication with hydraulic reservoir supplying hydraulic fluid.

3. The milling machine of claim 2, wherein the actuator flow control valve is configurable in a first actuator configuration establishing fluid communication between the first and second hydraulic actuators and the hydraulic pump to cause the first and second hydraulic actuators to vertically lower the first side plate and the second side plate with respect to the machine frame.

4. The milling machine of claim 3, wherein the actuator flow control valve is configurable in a second actuator configuration establishing fluid communication between the first and second hydraulic actuators and the hydraulic pump to cause the first and second hydraulic actuators to vertically raise the first side plate and the second side plate with respect to the machine frame.

5. The milling machine of claim 4, wherein the first and second hydraulic actuators are double-acting hydraulic cylinders.

6. The milling machine of claim 1, wherein the hydraulic system is operatively associated with a float circuit including an accumulator in fluid communication with the first hydraulic actuator and the second hydraulic actuator.

7. The milling machine of claim 6, wherein the float circuit includes an accumulator flow control valve disposed between the first and second hydraulic actuators and the accumulator.

8. The milling machine of claim 7, wherein the accumulator flow control valve is configurable in a first float configuration establishing fluid communication between the first and second hydraulic actuators and the accumulator.

9. The milling machine of claim 8, wherein the accumulator flow control valve is configurable in a second float configuration isolating the first and second hydraulic actuators from the accumulator.

10. The milling machine of claim 9, wherein the accumulator flow control valve is a bidirectional valve.

11. The milling machine of claim 1, wherein the plurality of sensors include at least one sensor aligned with the first lateral side of the machine frame and at least one sensor aligned with the second lateral side of the machine frame.

12. The milling machine of claim 1, wherein the plurality of sensors include forward sensors located forward of the rotor enclosure and rearward sensors located rearward of the rotor enclosure.

13. The milling machine of claim 1, wherein the plurality of sensors is selected from the group comprising acoustic sensors, laser sensors, infrared sensors, and ultraviolet sensors.

14. The milling machine of claim 1, wherein the plate elevation control system is adapted to raise and lower the first side plate aligned with the first lateral side and to raise and lower the second side plate aligned with the second lateral side independently of each other.

15. A method of operating a milling machine including a cutting rotor rotatably supported on a machine frame of the milling machine, the method comprising:
sensing a vertical distance between the machine frame and a work surface via a plurality of sensors mounted to the machine frame;
operating a hydraulic system to cause a side plate of a rotor enclosure accommodating the cutting rotor to rise with respect to the machine frame if the vertical distance between the machine frame and the work surface decreases; and
operating the hydraulic system to cause the side plate of the rotor enclosure accommodating the cutting rotor to lower with respect to the machine frame if the vertical distance between the machine frame and the work surface increases.

16. The method of claim 15, wherein the step of raising the side plate and the step of lowering the side plate are accomplished by configuring an actuator flow control valve of the hydraulic system to selectively direct hydraulic fluid to and from a hydraulic actuator operatively associated with the side plate.

17. The method of claim 16, further comprising floating the side plate with respect to the machine frame.

18. The method of claim 17, wherein the step of floating is accomplished by configuring an accumulator flow control valve to establish fluid communication between the hydraulic actuator and an accumulator.

19. A control system for a milling machine having a cutting rotor accommodated in a rotor enclosure for milling a work surface, the control system comprising:
a plurality of sensors mounted to a machine frame of the milling machine, the plurality of sensors sensing and generating sensor data indicative of a location of the work surface with respect to the machine frame;
a hydraulic system including at least a first hydraulic actuator operatively associated with a first side plate of the rotor enclosure and a second hydraulic actuator operatively associated with a second side plate of the rotor enclosure, the first and second hydraulic actuators configured to vertically raise and lower the first side plate and the second side plate with respect to the machine frame;
an electronic controller programmed with a plate elevation control system adapted to receive the sensor data communicated from the plurality of sensors, process the sensor data to determine a vertical distance between the work surface and at least one of the first side plate and the second side plate, and to operate the hydraulic system to raise at least one of the first side plate and second side plate if the vertical distance decrease and to lower at least one of the first side plate and the second side plate if the vertical distance increases.

20. The control system of claim 19, wherein the hydraulic system includes a float circuit with an accumulator and the plate elevation control system is adapted to commence a float step by establishing fluid communication between the first and second hydraulic actuators and the accumulator.
